(19) United States
(12) Patent Application Publication
(10) Pub. No.: US 2005/0079267 A1
(43) Pub. Date: Apr. 14, 2005

(54) Butter and cream cheese composition

(76) Inventor: Justin Erich Milano, Nesconset, NY (US)

Correspondence Address: Justin E. Milano, 93 Empress Pines Dr., Nesconset, NY, 11767, US

(21) Appl. No.: 10/845,321

(22) Filed: May 14, 2004

Related U.S. Application Data
(60) Provisional application No. 60/509,636, filed on Oct. 9, 2003.

(51) Int. Cl. A01J 1/00

(52) U.S. Cl. 426/581

(57) ABSTRACT

A consumer packaged composition of matter with 60% to 100% of the composition consisting of only butter and/or margarine, and cream cheese, with the remaining 0% to 40% of the composition containing any additional contents.

This application claims benefit of provisional application No. 60/509,636 filed on Oct. 9, 2003.

### BACKGROUND OF THE INVENTION

This invention is a consumer packaged food which pertains to the dairy industry. The claimed invention is a consumer packaged composition of butter and/or margarine, cream cheese, and any additional desired contents.

Butter and cream cheese are two of America's most favorite spreads. Butter for it's sweet taste and ability to melt into hot food. And cream cheese for it's creamy taste and smooth texture. Another one of America's favorite spreads is margarine for it's butter like properties and its low cost. By combining the spreads it creates one delicious spread with all the qualities and tastes combined. When the spread is used on hot food some butter will melt into the food while the rest of the spread will be soft on top of the food. The claimed invention goes excellent with bagels, toast, and potatoes.

The main object of the present invention is to provide a spread with all the qualities and flavors of butter and/or margarine and cream cheese consumer packaged for convenience which the end user would simply put or spread the combination on their desired food of choice.

### DETAILED DESCRIPTION OF THE INVENTION

The claimed invention is a consumer packaged composition of matter with sixty percent to one hundred percent of the composition consisting of only butter and/or margarine, and cream cheese, with the remaining zero percent to forty percent of the compositing containing any additional contents.

The process of making the composition claimed as the invention is mixing together using any ratio, butter and/or margarine, and cream cheese to make up the sixty percent to one hundred percent of the composition, plus any additional contents to make up the remaining zero percent to forty percent of the composition. The ideal way of mixing the composition is whipping it with air in a mixer until fully blended in a clean, sterile and refrigerated area using sixty percent regular cream cheese and forty percent salted whipped sweet cream butter with no additional ingredients. Then the composition is consumer packaged and distributed. The end user would simply put or spread the mixture on their desired food of choice.

What is also claimed is the process of making cream cheese in which any of its ingredients or additional additives are churned before, during, or after it's process. Also claimed is the product resulting from the process.

The word butter used in any of the claimed process' or compositions stands for any sweet cream butter, cultured cream butter, or any butter or butter like products salted or not salted, that are complete or incomplete in it's process, that are with or without any modifications before, during, or after it's process, or that contain any additional ingredients. It also stands for any product in which churning is a part of its process or in other words anything churned.

The word margarine used in any of the claimed process' or compositions stands for any type of margarine, any margarine like products, anything solidified, anything with oil (except a cheese), or any kind of oil, that are complete or incomplete in it's process, that contain any percent fat or moisture, that are with or without any modifications before, during, or after it's process, or that contain any additional ingredients.

As well the words cream cheese used in any of the claimed process' or compositions stands for any regular, low-fat, or non-fat cream cheese, Neuchâtel cheese, or any cream cheese like products that are complete or incomplete in it's process, that contain any percent milk-fat or moisture, that are with or without any modifications before, during, or after it's process, or that contain any additional ingredients. Or any cheese, soft cheese, or any cheese like cultures that are complete or incomplete in it's process, that contain any percent milk-fat or moisture, that are with or without any modifications before, during, or after it's process, or that contain any additional ingredients.

1) A consumer packaged composition comprising a butter and cream cheese combination with 60% to 100% of the composition containing, having any ratio between them, only part butter and/or margarine and part cream cheese, with the remaining 0% to 40% of the composition containing any other contents

2) The process of combining and packaging butter and/or margarine, cream cheese and any other contents together at any point before, during, or after their process to create the composition claimed in claim 1

3) The process of cream cheese in which any of it's ingredients or additional additives are churned before, during, or after it's process

4) The product resulting from the process claimed in claim 3

5) The composition or process claimed in claim 1 or 2 wherein the word butter stands for any sweet cream butter, cultured cream butter, or any butter or butter like products salted or not salted, that are complete or incomplete in it's process, that are with or without any modifications before, during, or after it's process, or that contain any additional ingredients. It also stands for any product in which churning is a part of its process or in other words anything churned.

6) The composition or process claimed in claim 1 or 2 wherein word margarine stands for any type of margarine, any margarine like products, anything solidified, anything with oil (except a cheese), or any kind of oil, that are complete or incomplete in it's process, that contain any percent fat or moisture, that are with or without any modifications before, during, or after it's process, or that contain any additional ingredients

7) The composition or process claimed in claim 1, 2 or 3 wherein the word cream cheese stands for any regular, low-fat, or non-fat cream cheese, Neuchâtel cheese, or any cream cheese like products that are complete or incomplete in it's process, that contain any percent milk-fat or moisture, that are with or without any modifications before, during, or after it's process, or that contain any additional ingredients. Or any cheese, soft cheese, or any cheese like cultures that are complete or incomplete in it's process, that contain any percent milk-fat or moisture, that are with or without any modifications before, during, or after it's process, or that contain any additional ingredients.
